(19) United States
(12) Patent Application Publication
(10) Pub. No.: US 2025/0043785 A1
(43) Pub. Date: Feb. 6, 2025

(54) UNIFIED VEHICLE PUMP

(71) Applicant: Atieva, Inc., Newark, CA (US)

(72) Inventor: Daniel Morris, San Marcos, CA (US)

(21) Appl. No.: 18/364,145

(22) Filed: Aug. 2, 2023

(51) Int. Cl. F04C 29/00; B60G 99/00; B60H 1/32; B60L 50/60; F04C 18/02; F04C 23/00

(52) U.S. Cl. CPC F04C 29/005; B60G 99/008; B60H 1/3222; B60L 50/60; F04C 18/0215; F04C 23/001

(57) ABSTRACT

An electric vehicle includes a battery, a first gas compressor and a second gas compressor. The first gas compressor is configured for compressing a first gas and providing the compressed first gas to a first system of the electric vehicle, and the first compressor includes a shaft and an electric motor. The electric motor is electrically connected to the battery to receive electrical power from the battery and is configured to convert the received electrical power into rotational motion of the shaft. The electric vehicle also includes a second gas compressor configured for compressing a second gas and providing the compressed second gas to a second system of the electric vehicle. The electric vehicle also includes a coupling configured for mechanically coupling power from the electric motor to the second gas compressor.

### TECHNICAL FIELD

This document relates to pumps used in vehicles and, in particular, to methods and apparatuses for operating multiple pumps or compressors with a single motor in a unified vehicle pump configuration.

### BACKGROUND

Automotive vehicles include one or more main motors configured for driving wheels of the vehicle. Automotive vehicles also can include auxiliary and accessory equipment, such as, for example, cooling fans, air conditioning (or refrigerant) compressors, power steering pumps, cooling pumps, air suspension compressors, etc. The auxiliary and accessory equipment can be powered by the main motor or by one or more auxiliary motors. For example, in an internal combustion vehicle, a serpentine belt may transfer power from a main motor to one or more pieces of auxiliary and accessory equipment. In another example, in an electric vehicle, a plurality of dedicated electric motors, powered by the battery of the electric vehicle, can drive a plurality of components of the electric vehicle.

However, including a dedicated electric motor for different components of the system can add cost, complexity, and part count to the vehicle.

### SUMMARY

In some aspects, the techniques described herein relate to an electric vehicle that includes a battery, a first gas compressor and a second gas compressor. The first gas compressor is configured for compressing a first gas and providing the compressed first gas to a first system of the electric vehicle, and the first compressor includes a shaft and an electric motor. The electric motor is electrically connected to the battery to receive electrical power from the battery and is configured to convert the received electrical power into rotational motion of the shaft. The electric vehicle also includes a second gas compressor configured for compressing a second gas and providing the compressed second gas to a second system of the electric vehicle. The electric vehicle also includes a coupling configured for mechanically coupling power from the electric motor to the second gas compressor.

Implementations include one or more of the following features, which can be combined in any combination. For example, the first gas compressor can include an air conditioning compressor, where the first gas is a refrigerant gas of an air conditioning system, and the second gas compressor and the second system of the vehicle is an air suspension system, and the second gas compressor is configured for providing the compressed second gas to the air suspension system.

In another example, the electric motor can include an inverter configured to convert direct current power received from the battery to high voltage alternating current to drive the electric motor. In another example, the electric motor can be a high-voltage, variable-speed, alternating current motor. In another example, the motor can be configured to operate at voltages between 200 Volts and 1000 Volts.

In another example, the coupling includes a mechanical clutch. In another example, the coupling includes a set of gears configured to engage and disengage when the shaft is stopped. In another example, the coupling includes a one-way roller clutch configured to engage and couple power from the electric motor to the second gas compressor when the shaft is rotating in a first direction and to disengage and not couple power from the electric motor to the second gas compressor when the shaft is rotating in a second direction opposite the first direction.

In some aspects, the techniques described herein relate to a unified vehicle pump that includes: a first gas compressor configured for compressing a first gas and providing the compressed first gas to a first system of an electric vehicle, where the first compressor includes a shaft and an electric motor that is electrically connected to a battery of the electric vehicle to receive electrical power from the battery and is configured to convert the received electrical power into rotational motion of the shaft; a second gas compressor configured for compressing a second gas and providing the compressed second gas to a second system of the electric vehicle; and a coupling configured for mechanically coupling power from the electric motor to the second gas compressor.

Implementations include one or more of the following features, which can be combined in any combination. For example, the first gas compressor can include an air conditioning compressor, where the first gas is a refrigerant gas of an air conditioning system, and the second gas compressor can be an air compressor and the second system of the vehicle is an air suspension system and the second gas compressor is configured for providing the compressed second gas to the air suspension system.

In another example, the electric motor can include an inverter configured to convert direct current power received from the battery to high voltage alternating current to drive the electric motor. In another example, electric motor can be a high-voltage, variable-speed, alternating current motor. In another example, the motor can be configured to operate at voltages between 200 Volts and 1000 Volts.

In another example, the coupling can include a mechanical clutch. In another example, the coupling can include a set of gears configured to engage and disengage when the shaft is stopped. In another example, the coupling can include a one-way roller clutch configured to engage and couple power from the electric motor to the second gas compressor when the shaft is rotating in a first direction and to disengage and not couple power from the electric motor to the second gas compressor when the shaft is rotating in a second direction opposite the first direction.

In some aspects, the techniques described herein relate to a method including: operating an electric motor of an electric vehicle in a first operating mode to drive a first gas compressor, the electric motor being integrated with the first gas compressor; mechanically coupling a shaft driven by the electric motor to a second gas compressor; and operating the electric motor in a second operating mode to drive the second gas compressor.

Implementations include one or more of the following features, which can be combined in any combination. For example, operating the electric motor in the first operating mode can include operating the electric motor at different speeds.

In another example, operating the electric motor in the first operating mode can include operating rotating the shaft in a first direction, and operating the electric motor in the second operating mode can include rotating the shaft in a second direction opposite the first direction.

In another example, the first gas compressor can include an air conditioning compressor of an air conditioning system and the second gas compressor can include an air compressor of an air suspension system.

### BRIEF DESCRIPTION OF DRAWINGS

FIG. 1 is an example perspective view of a vehicle.

FIG. 2 is an example schematic perspective view of the vehicle of FIG. 1, in which various components located within or below the body of the vehicle are shown.

FIG. 3 is a schematic diagram of an implementation of unified vehicle pump.

FIG. 4 is a flowchart of a process for operating a unified vehicle pump in an electric vehicle.

Like reference symbols in the various drawings indicate like elements.

### DETAILED DESCRIPTION

A plurality of individual electric motors can be provided in an electric vehicle for powering different accessory and auxiliary pieces of equipment in the vehicle, and the specifications of each electric motor can be selected based on its intended use to enhance the efficiency of the motor's operation. However, the cost and complexity of including many different accessory and auxiliary pieces of equipment in a vehicle can be problematic. Therefore, a need exists for reducing the number of parts in a vehicle and for reducing the space occupied by the parts, which can reduce the total parts count of the vehicle, as well as the weight and cost of the vehicle.

This document describes examples of systems and techniques that provide a unified vehicle pump in an electric vehicle, in which a single electric motor provides power to a plurality of accessory and auxiliary pieces of equipment in the electric vehicle. In a particular implementation, a single electric motor powers both an air conditioning compressor of an air conditioning system and an air suspension compressor of an air suspension system. In some implementations, the electric motor can be integrated with the air conditioning compressor that it powers and can be coupled to the air suspension compressor that it also powers.

Examples herein refer to a vehicle. A vehicle is a machine that transports passengers or cargo, or both. A vehicle can have one or more motors using at least one type of fuel or other energy source (e.g., electricity). Examples of vehicles include, but are not limited to, cars, trucks, and buses. The number of wheels can differ between types of vehicles, and one or more (e.g., all) of the wheels can be used for propulsion of the vehicle, or the vehicle can be unpowered (e.g., when a trailer is attached to another vehicle). The vehicle can include a passenger cabin accommodating one or more people.

Examples described herein refer to a top, bottom, front, side, or rear. These and similar expressions identify things or aspects in a relative way based on an express or arbitrary notion of perspective. That is, these terms are illustrative only, used for purposes of explanation, and do not necessarily indicate the only possible position, direction, and so on.

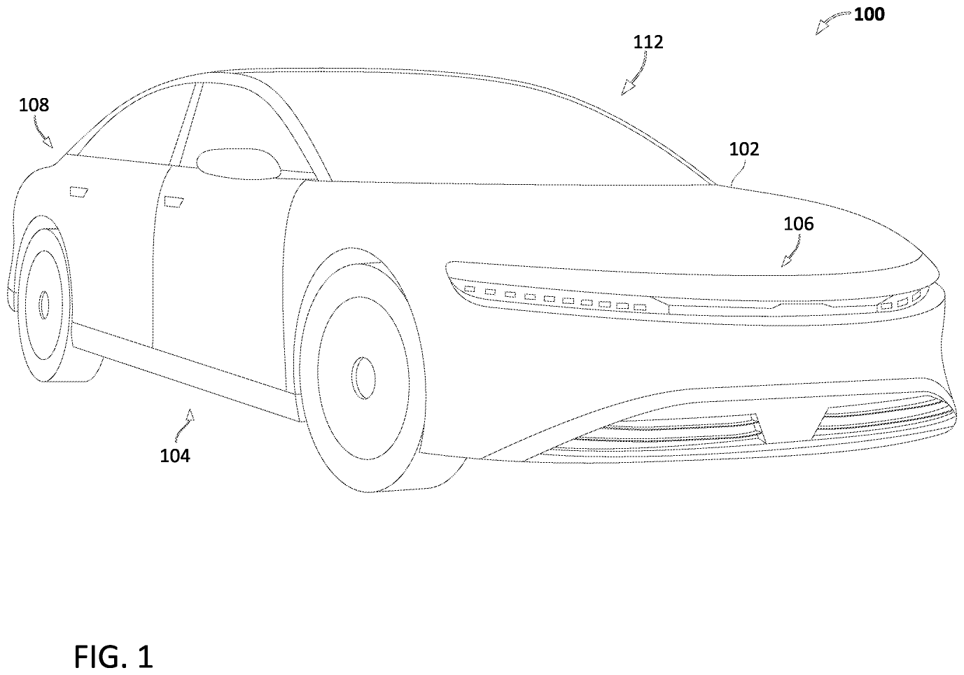

FIG. 1 is an example perspective view of a vehicle 100. The vehicle 100 can be used with one or more other examples described elsewhere herein. The vehicle 100 includes a vehicle body 102 and a vehicle chassis 104 supporting the vehicle body 102. For example, the vehicle body 102 of FIG. 1 is a four-door type of vehicle with room for at least four occupants, and the vehicle chassis 104 has four wheels. Other numbers of doors, wheel counts, vehicle purpose, types of vehicle body 102, and/or kinds of vehicle chassis 104 can be used in some implementations.

The vehicle body 102 has a front 106 and a rear 108 and can have a passenger cabin 112 between the front and the rear. The vehicle 100 can have at least one motor, which can be positioned in one or more locations of the vehicle 100. In some implementations, the motor(s) can be mounted generally near the front 106, generally near the rear 108, or both. A battery module can be supported by the vehicle chassis 104, for example, below the passenger cabin and can be used to power the motor(s). The one or more motor(s) can receive electrical power from the barter module and use the power received from the battery to propel the vehicle 100 and to provide accessory and auxiliary features of the vehicle. Thus, the vehicle 100 can be an “electric vehicle,” in that the vehicle can be propelled by energy received from the battery. In some implementations, the electric vehicle and be an all-electric vehicle that does not include an internal combustion engine. In some implementation, the electric vehicle can be a hybrid vehicle that can be propelled by energy received from the battery, energy generated by an internal combustion engine, or a combination of energy received from both the battery and generated by the internal combustion engine.

The rear 108 of the vehicle 100 can include a trunk compartment, and the front 106 of the vehicle 100 can include a front trunk (a.k.a., frunk) compartment, each of which is outside the passenger cabin and each of which can be used for storage of vehicle components or personal equipment.

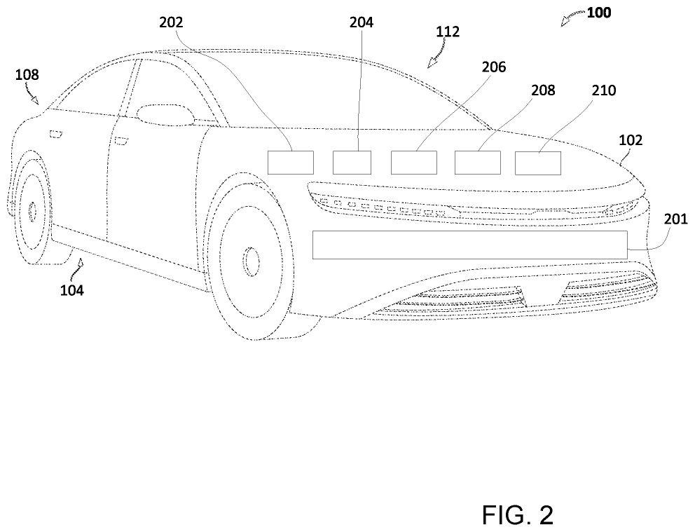

FIG. 2 is an example schematic perspective view of the vehicle 100, in which various components located within or below the body of the vehicle are shown. For example, the vehicle 100 can include a battery 201 that stores energy that can be used to drive the wheels of the vehicle and to power various components of the vehicle.

The vehicle 100 can include an air conditioning system 202 that can provide, for example, temperature and humidity controlled air to the passenger cabin of the vehicle. The air conditioning system 202 can include an air conditioning compressor that compresses refrigerant gas that is used in the air conditioning system. The compressor can be one of a variety of compressor types, including a scroll compressor, a spool compressor, a rotary vane compressor, etc. The air conditioning system 202 can include an inverter and an electric motor. The inverter can receive direct current (DC) electrical power from the battery 201 and can convert the DC power to alternating current (AC) power that is provided to the electric motor, and the compressor can be driven by the electric motor. The electric motor can be integrated with the compressor. For example, the electric motor and the compressor can share a common housing. The electric motor can convert the electrical power received from the battery into rotational motion of a shaft that drives the motion of components of the compressor, so that the refrigerant gas is compressed. The invertor also can include a processor that controls the frequency of the AC current provided to the electric motor to control the speed of the compressor.

The compressor of the air conditioning system 202 can include an inlet and an outlet each connected to one or more respective refrigerant conduits in the air conditioning system 202 and can act on the refrigerant gas to compress the gas. The compressor can operate at multiple speeds (e.g., within a range of operating speeds expressed in revolutions per minute or another unit). The speed of the compressor can be controlled by the AC current provided by the inventor, which, in turn, can be controlled by the processor of the inventor.

The vehicle 100 can include an air suspension system 204 that can control a height of the body of the vehicle above the roadway on which the vehicle travels and that can control the amount of dampening of vibrations experienced by the body as the vehicle travels over an uneven roadway. The air suspension system 204 can include, for example, one or more air springs at each wheel, and an air compressor that can be used to set an air pressure in each air spring to achieve a desired ride height and damping amount. In some implementations, the air suspension system can include a compressed air storage tank to maintain a reservoir or high pressure gas that can be quickly delivered to one or more air springs to achieve a change of ride height or damping amount within a predetermined amount of time. The air compressor of the air suspension system 204 can re-supply compressed air to the air storage tank when the pressure in the tank drops below a threshold value.

The vehicle can include one or more coolant pumps 206 that can be configured for circulating coolant to different components of the vehicle 100, for example, to cool the battery 201 while the battery is being charged, to cool the electric traction motors that drive the wheels of the vehicle, etc. The coolant pumps 206 can include one or more mechanical drive units (e.g., an impeller) for coolant through a coolant system.

The vehicle can include one or more oil pumps 208 that can be configured for circulating oil in the powertrain, and for providing lubrication to different systems in the vehicle. The oil pumps 208 can include one or more mechanical drive units (e.g., an impeller) for coolant through an oil circulation system.

A single electric motor can be configured to power a combination two or more of mechanical drives of the air conditioning system 202 (e.g., the air conditioning compressor of the air conditioning system 202), the air suspension system 204 (e.g., the gas compressor of the air suspension system 204), the coolant pumps 206 (e.g., an impeller of a pump), and the oil pumps 208 (e.g., an impeller of a pump). For example, when the electric motor is integrated within a system 202, 204 or a pump 206, 208, a mechanical coupling 210 can transmit power from the electric motor to another system or pump. In this manner, the overall part count and complexity of the vehicle and the cost of the vehicle can be reduced.

The mechanical coupling 210 can be any mechanical coupling between the electric motor of a compressor or pump, which mechanically couples power from the motor to another compressor or pump of the vehicle 100. The mechanical coupling 210 can be implemented in a variety of forms. For example, in some implementations, the mechanical coupling 210 can include a clutch for transmitting power on demand from the electric motor of one system or pump to another system or pump. In some implementations, the mechanical coupling 210 can include a set of gears configured that can transmit power from the electric motor to another compressor or pump. The gears can be configured to engage and disengage with each other when the shaft of the electric motor is not rotating. In some implementations, the mechanical coupling 210 can include a one-way roller clutch that is configured to engage and couple power from the electric motor to another compressor or pump when the shaft of the motor is rotating in a first direction and to disengage and not couple power from the electric motor to the other compressor or pump when the shaft is rotating in a second direction opposite the first direction.

Because the speed and the power output of the electric motor can be controlled (e.g., by controlling the voltage, current, and frequency of AC electrical power supplied to the motor), the power supplied to both the compressor or pump with which the electric motor is integrated and to the other compressor or pump with which the electric motor is mechanically coupled can be optimized for efficient operation of both compressors/pumps that are powered by the electric motor. In some implementations, the voltage, current, and frequency of the electrical power supplied to the compressor or pump with which the electric motor is integrated can be different than the voltage, current, and frequency of the electrical power supplied to the other compressor or pump with which the electric motor is mechanically coupled to optimize the efficiency of the operation of each device.

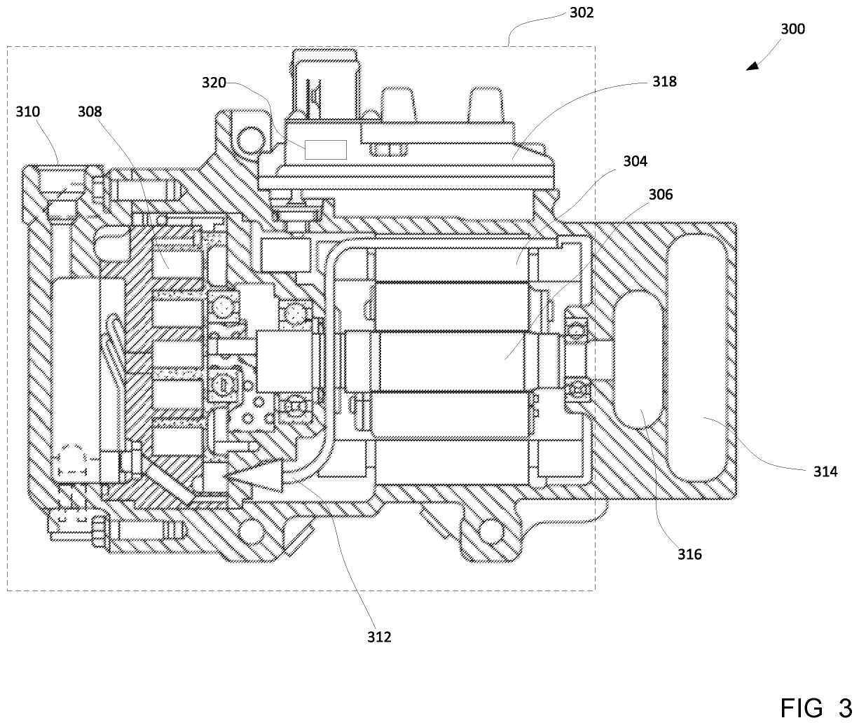

FIG. 3 is a schematic diagram of an implementation of unified vehicle pump 300. The unified vehicle pump 300 in the implementation shown in FIG. 3 includes a first gas compressor 302 that can compress a first gas and that provides the compressed first gas to a first system of an electric vehicle. The first gas can be a refrigerant gas and the system can be an air conditioning system. The first compressor 302 includes an electric motor 304 that is electrically connected to a battery of an electric vehicle and that receives electrical power from the battery. The electric motor includes and/or is connected to a shaft 306, and operation of the motor 304 converts the electrical power received from the battery into rotational motion of the shaft to cause the shaft 306 to rotate. One end of the shaft 306 is connected to a scroll 308 that rotates within a counterpart scroll to suck in low pressure gas, compress the gas, and expel the gas from an output port 310 of the compressor. A flow direction 312 of the gas shows how the gas that enters the compressor 302 flows around the electric motor 304 to cool the motor and then enters the scroll 308.

The unified vehicle pump 300 further includes a second gas compressor 314 configured for compressing a second gas and providing the compressed second gas to a second system of the electric vehicle. The second gas compressor 314 can be an air compressor, and the second system of the vehicle can be an air suspension system, where the second gas compressor is configured for providing the compressed second gas to the air suspension system. Like the first gas compressor 302, the second gas compressor 314 can be one of a variety of compressor types, including a scroll compressor, a spool compressor, a rotary vane compressor, etc., and the principle of operating of the second gas compressor 314 can be similar to that of the first gas compressor 302.

The unified vehicle pump 300 includes a mechanical coupling 316 that is configured for mechanically coupling power from the electric motor 304 of the first gas compressor 302 to the second gas compressor 314, so the electric motor 304 can power both the first gas compressor 302 and the second gas compressor 314. The mechanical coupling 316 can mechanically couple the shaft 306 of the first compressor 302 to the second gas compressor 314, so that the electric motor can provide the power to the second compressor to do work on gas that is input into the second compressor. By powering both the first gas compressor 302 and the second gas compressor 314 with a single electric motor, fewer electric motors are needed in the electric vehicle compared to if each compressor included its own dedicated electric motor.

The mechanical coupling 316 can be implemented in a number of different forms. In some implementations, the mechanical coupling 316 can include a mechanical clutch that can be selectively engaged with the shaft 306 to couple power from the electric motor 304 to the second compressor and disengaged from the shaft 306, so that power is not coupled from the motor to the second compressor. The clutch may be engaged and disengaged while the shaft is rotating. In some implementations, the mechanical coupling 316 can include a one-way roller clutch that is configured to engage with the shaft 306 to couple power from the electric motor 304 to the second gas compressor 314 when the shaft 306 is rotating in a first direction and to disengage with the shaft 306 and not couple power from the electric motor 304 to the second gas compressor 314 when the shaft 306 is rotating in a second direction opposite the first direction. Thus, in this implementation, the mechanical coupling 316 can be engaged by causing the shaft to rotate in one direction and can be disengaged by causing the shaft 306 to rotate in the second direction.

In some implementations, the mechanical coupling 316 can include a set of gears (e.g., including at least a gear that rotates with the shaft 306 and a gear attached to the second compressor) that can be selectively engaged and to couple power from the electric motor 304 to the second compressor and disengaged, so that power is not coupled from the motor to the second compressor. In some implementations, the gears are engaged and disengaged when the shaft 306 is not rotating.

In some implementations, the electric motor 304 of the unified vehicle pump 300 can be a high-voltage (e.g., operating at over 100 Volts), variable-speed, alternating current motor. In some implementations, the electric motor 304 can be configured to operate at a voltage between 200 Volts and 1000 Volts, and, in some implementations, the electric motor 304 can be configured to operate at a plurality of different voltages between 200 Volts and 1000 Volts. In some implementations, the electric motor 304 can be configured to operate at a plurality of different rotational speeds between 1000 rpm and 5000 rpm. By operating the electric motor at different voltages and speeds, the electric motor can supply different amounts of power to the components it drives according to the demand from the different components. For example, when a high rate of cooling is required by the passenger cabin of the vehicle, the motor can operate at a high voltage and a high speed, but once the passenger cabin has reached a desired temperature, the motor may operate at a lower voltage and speed to maintain the desired temperature.

When the first gas compressor 302 is an air conditioning compressor, the power required to operate the electric motor 304 to drive the first compressor 302 can be relatively high compared to powers that are typically provided to other compressors of an electric vehicle. For example, dedicated electric motors used to drive air compressors in an air suspension system, typically operate in conjunction with a compressed air storage tank to maintain a high pressure of gas in the storage tank that can be called upon to rapidly change a ride height or suspension dampening of the vehicle, and therefore such motors can be of a relatively lower power because they can operate over a period of time (e.g., 30-120 seconds) to replenish the compressed air in the storage tank after air from the tank is used to make a rapid changes (e.g., in less than five seconds) in the air suspension system. However, when the relatively high-power electric motor 304 of the first gas compressor 302 is coupled to the second compressor and used to power the second compressor, the higher power of the electric motor of the air conditioning compressor can be used to make rapid changes to the air suspension system without requiring the use of an air storage tank. Therefore, the air storage tank can be eliminated from the air suspension system with the unified vehicle pump 300 is used, which reduces weight, cost, and total part count in the vehicle and also allows for the volume that otherwise would have been used for the air storage tank to be used for other purposes, such as, for example, a larger battery in the vehicle.

In some implementations, the electric motor 304 includes an inverter 318 that is configured to convert direct current power received from the battery to high voltage alternating current to drive the electric motor. The inverter 318 can include control logic 320 (e.g., a processor, an electronic circuit, etc.) that is configured to control operation of the electric motor 304. The control logic 320 can control, for example, the voltage, current, and frequency of electric power provided to the electric motor 304, so that operation of the electric motor can be optimized for driving the first gas compressor 302 and the second gas compressor 314 and to manage transitions between driving the first gas compressor 302 and the second gas compressor 314. For example, the when the first gas compressor 302 is an air conditioning compressor and the second gas compressor 314 is an air compressor for an air suspension system, the control logic 320 can receive signals (e.g., from a main processor of the vehicle) that specify a first particular operating mode of the electric motor 304, and the inverter 318 can then provide the electric inputs to the motor to execute the first particular operating mode. Then, when the electric motor 304 is called upon to drive the second gas compressor 314 (e.g., by signals from a man processor of the vehicle), the mechanical coupling 316 can be engaged to transmit power from the electric motor 304 to the second gas compressor, and the control logic 320 can receive signals that specify a second particular operating mode of the electric motor 304, and the inverter 318 can then provide the electric inputs to the motor to execute the second particular operating mode.

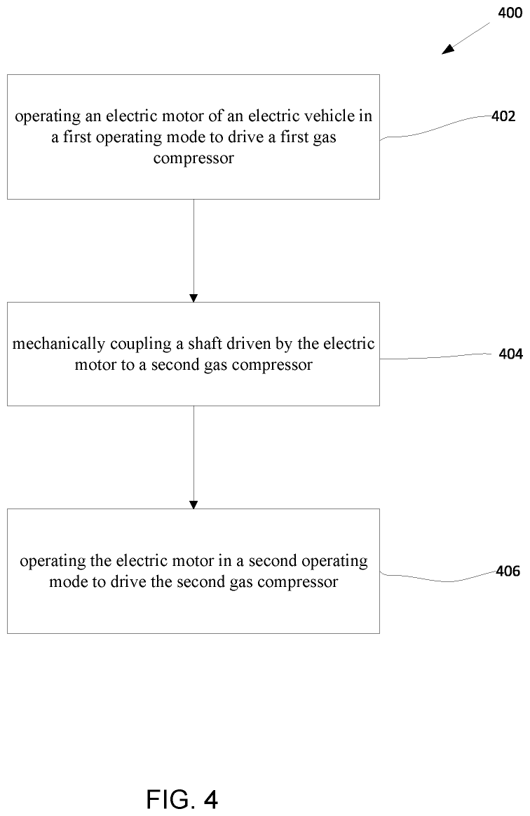

FIG. 4 is a flowchart of a process 400 for operating a unified vehicle pump in an electric vehicle. The process 400 includes operating an electric motor of an electric vehicle in a first operating mode to drive a first gas compressor (402), where the electric motor is integrated with the first gas compressor. The process 400 includes mechanically coupling a shaft driven by the electric motor to a second gas compressor (404). The process 400 also includes operating the electric motor in a second operating mode to drive the second gas compressor (406). As described here, in various implementations, operating the electric motor in the first operating mode can include operating the electric motor at different speeds. Operating the electric motor in the first operating mode can include rotating the shaft in a first direction, and operating the electric motor in the second operating mode includes rotating the shaft in a second direction opposite the first direction. The first gas compressor can include an air conditioning compressor of an air conditioning system and the second gas compressor can include an air compressor of an air suspension system.

The terms “substantially” and “about” used throughout this Specification are used to describe and account for small fluctuations, such as due to variations in processing. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%. Also, when used herein, an indefinite article such as “a” or “an” means “at least one.”

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

A number of implementations have been described. Nevertheless, it will be understood that various modifications may be made without departing from the spirit and scope of the specification.

In addition, the logic flows depicted in the figures do not require the particular order shown, or sequential order, to achieve desirable results. In addition, other processes may be provided, or processes may be eliminated, from the described flows, and other components may be added to, or removed from, the described systems. Accordingly, other implementations are within the scope of the following claims.

While certain features of the described implementations have been illustrated as described herein, many modifications, substitutions, changes and equivalents will now occur to those skilled in the art. It is, therefore, to be understood that appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

What is claimed is:

1. An electric vehicle comprising:
a battery;
a first gas compressor configured for compressing a first gas and providing the compressed first gas to a first system of the electric vehicle, wherein the first gas compressor includes a shaft and an electric motor that is electrically connected to the battery to receive electrical power from the battery and is configured to convert the received electrical power into rotational motion of the shaft;
a second gas compressor configured for compressing a second gas and providing the compressed second gas to a second system of the electric vehicle; and
a coupling configured for mechanically coupling power from the electric motor to the second gas compressor.

2. The electric vehicle of claim 1,
wherein the first gas compressor includes an air conditioning compressor, wherein the first gas is a refrigerant gas of an air conditioning system, and
wherein the second gas compressor includes an air compressor, and the second system of the vehicle is an air suspension system, and the second gas compressor is configured for providing the compressed second gas to the air suspension system.

3. The electric vehicle of claim 1, wherein the electric motor includes an inverter configured to convert direct current power received from the battery to high voltage alternating current to drive the electric motor.

4. The electric vehicle of claim 3, wherein electric motor is a high-voltage, variable-speed, alternating current motor.

5. The electric vehicle of claim 4, wherein the motor is configured to operate at voltages between 200 Volts and 1000 Volts.

6. The electric vehicle of claim 1, wherein the coupling includes a mechanical clutch.

7. The electric vehicle of claim 1, wherein the coupling includes a set of gears configured to engage and disengage when the shaft is stopped.

8. The electric vehicle of claim 1, wherein the coupling includes a one-way roller clutch configured to engage and couple power from the electric motor to the second gas compressor when the shaft is rotating in a first direction and to disengage and not couple power from the electric motor to the second gas compressor when the shaft is rotating in a second direction opposite the first direction.

9. A unified vehicle pump comprising:
a first gas compressor configured for compressing a first gas and providing the compressed first gas to a first system of an electric vehicle, wherein the first gas compressor includes a shaft and an electric motor that is electrically connected to a battery of the electric vehicle to receive electrical power from the battery and is configured to convert the received electrical power into rotational motion of the shaft;
a second gas compressor configured for compressing a second gas and providing the compressed second gas to a second system of the electric vehicle; and
a coupling configured for mechanically coupling power from the electric motor to the second gas compressor.

10. The unified vehicle pump of claim 9,
wherein the first gas compressor includes an air conditioning compressor, wherein the first gas is a refrigerant gas of an air conditioning system, and
wherein the second gas compressor is an air compressor, and the second system of the vehicle is an air suspension system, and the second gas compressor is configured for providing the compressed second gas to the air suspension system.

11. The unified vehicle pump of claim 9, wherein the electric motor includes an inverter configured to convert direct current power received from the battery to high voltage alternating current to drive the electric motor.

12. The unified vehicle pump of claim 11, wherein electric motor is a high-voltage, variable-speed, alternating current motor.

13. The unified vehicle pump of claim 12, wherein the motor is configured to operate at voltages between 200 Volts and 1000 Volts.

14. The unified vehicle pump of claim 9, wherein the coupling includes a mechanical clutch.

15. The unified vehicle pump of claim 9, wherein the coupling includes a set of gears configured to engage and disengage when the shaft is stopped.

16. The unified vehicle pump of claim 9, wherein the coupling includes a one-way roller clutch configured to engage and couple power from the electric motor to the second gas compressor when the shaft is rotating in a first direction and to disengage and not couple power from the electric motor to the second gas compressor when the shaft is rotating in a second direction opposite the first direction.

17. A method comprising:
operating an electric motor of an electric vehicle in a first operating mode to drive a first gas compressor, the electric motor being integrated with the first gas compressor;
mechanically coupling a shaft driven by the electric motor to a second gas compressor; and
operating the electric motor in a second operating mode to drive the second gas compressor.

18. The method of claim 17, wherein operating the electric motor in the first operating mode includes operating the electric motor at different speeds.

19. The method of claim 17, wherein operating the electric motor in the first operating mode includes operating rotating the shaft in a first direction, and wherein operating the electric motor in the second operating mode includes rotating the shaft in a second direction opposite the first direction.

20. The method of claim 17, wherein the first gas compressor includes an air conditioning compressor of an air conditioning system and wherein the second gas compressor includes an air compressor of an air suspension system.
